(19) United States
(12) Patent Application Publication
(10) Pub. No.: US 2014/0157879 A1
(43) Pub. Date: Jun. 12, 2014

(54) METHOD AND DEVICE FOR TESTING A LIQUID

(71) Applicants: Sebastian Zamani, Stockholm (SE); Fredrik Strååt, Stockholm (SE)

(72) Inventors: Sebastian Zamani, Stockholm (SE); Fredrik Strååt, Stockholm (SE)

(21) Appl. No.: 14/131,545

(22) PCT Filed: Jul. 3, 2012
(86) PCT No.: PCT/SE2012/050765

§ 371 Date: Jan. 8, 2014

(30) Foreign Application Priority Data
Jul. 11, 2011 (SE) 1150657-3

(51) Int. Cl. G01N 29/024

(52) U.S. Cl. CPC G01N 29/024
USPC 73/64.53

(57) ABSTRACT

A measuring device (2) for testing a liquid (4) used as reducing agent in connection with exhaust cleaning for exhaust gases from a combustion engine. A temperature sensor (6) measures the temperature in the liquid. An acoustic velocity measuring unit (8) measures the acoustic velocity in the liquid. The measured first temperature T1 for the liquid and a first acoustic velocity v₁ for the liquid at the temperature T1 are delivered to a calculation unit (10). The temperature sensor determines a second temperature T2 for the liquid and delivers a temperature signal (12) to the calculation unit (10). That unit calculates the absolute value of a temperature difference ΔT between T1 and T2, i.e. ΔT=|T1−T2, and compares ΔT with a predetermined threshold value T_{TH}. If ΔT exceeds T_{TH}, the acoustic velocity measuring unit (8) determines a second acoustic velocity v₂ for the liquid at the temperature T2 to deliver an acoustic velocity signal (14) to the calculation unit (10), which compares v₁ and v₂ with reference values v_{ref1} and v_{ref2} for a reference liquid at the respective temperatures T1 and T2. An approved indicating signal (18) is generated if the measured values v₁ and v₂ are within approved velocity ranges, but not approved if v₁ and v₂ are not within those ranges.

### FIELD OF THE INVENTION

The present invention relates to a method for testing a liquid used as reducing agent in connection with exhaust cleaning, and a measuring device for implementing the method, according to the preambles of the independent claims.

### BACKGROUND TO THE INVENTION

A combustion engine burns a mixture of air and fuel in order to generate driving torque. The combustion process generates exhaust gases which are released from the engine to the atmosphere. The exhaust gases comprise nitrogen oxides (NO_{X}), carbon dioxide (CO₂), carbon monoxide (CO) and particles. NO_{X} is a composite term denoting exhaust gases which consist primarily of nitrogen oxide (NO) and nitrogen dioxide (NO₂). An exhaust post-treatment system treats exhaust discharges in order to decrease them before they are released to the atmosphere. In an exemplified exhaust post-treatment system, a dosing system injects a reducing agent into the exhaust gases upstream of a selective catalytic reduction catalyst (SCR catalyst). The mixture of exhaust gases and reducing agent reacts in the SCR catalyst and thereby reduces the amounts of NO_{X} discharged to the atmosphere.

An example of a reducing agent is liquid urea, commercially available in the form of AdBlue®. This liquid is a non-toxic urea solution in water and is used to chemically reduce discharges of nitrogen oxides, particularly from diesel-powered heavy vehicles. AdBlue® has a freezing point of −11° C. and the maximum temperature is about 60-70° C.

The reducing agent reacts with NO_{X} in the SCR catalyst to effect the NO_{X} reduction. More specifically, the reducing agent is broken down and forms ammonia (NH₃) which then reacts with NO_{X} to form water (H₂O) and nitrogen gas (N₂).

To achieve the NO_{X} reduction described, NH₃ has to be stored in the SCR catalyst. For the SCR catalyst to work effectively, this storage has to be at an appropriate level. In more detail, the NO_{X} reduction, the conversion effectiveness, depends on the storage level. Maintaining high conversion effectiveness in different operating states depends on maintaining the store of NH₃. The NH₃ level does however have to be lowered progressively as the temperature of the SCR catalyst rises, to avoid NH₃ discharges (i.e. surplus NH₃ being released from the SCR catalyst) which might decrease the conversion effectiveness of the catalyst.

In brief, to meet stricter environmental requirements, vehicle manufacturers are increasingly using SCR catalyst systems to remove nitrogen oxides (NO_{X}) from exhaust gases. This is done by injecting ammonia solution into a SCR catalyst to help to convert NO_{X} particles to nitrogen gas and water. The exhaust cleaning strategy needs to cater for sufficient NO_{X} to be converted while at the same time trying not to inject too much reducing agent, for both environmental and operational economy reasons.

Within the EU there are for example requirements concerning exhaust emission levels and types of reducing agent to be used. Future requirements may inter alia include it being possible to determine the quality of the reducing agent used.

A way of determining reducing agent quality is to measure the acoustic velocity in combination with measuring the temperature.

The acoustic velocity in liquids may be determined by the formula

v_{liquid}=√K(p)/ρ(T))

in which K(p) is the liquid's compression factor, which depends on the pressure p, and ρ(T) is the density of the liquid.

As the density of liquids is temperature-dependent, this has to be compensated for by measuring the temperature of the liquid. In the same way, the liquid's compression factor is pressure-dependent but to only a very small extent (relative to atmospheric pressure).

FIG. 1 is a graph illustrating schematically the relationship between acoustic velocity (m/s) and temperature for the following liquids:

A: Glycol

B: Urea of AdBlue type

C: Diluted AdBlue

D: Water

The graph is to the effect that different liquids have different acoustic velocities at different temperatures, but there are liquids which have the same acoustic velocity at the same temperature, e.g. glycol and brine, which have at about 35° C. the same acoustic velocity as AdBlue. Distinguishing between these liquids involves using in addition, according to a known device, a conductivity sensor and determining the conductivity of the liquids. The fact that the conductivity of AdBlue differs from that of glycol makes it possible to distinguish these liquids. However, the involvement of a further sensor causes increased complexity and consequently more expense and greater risk of error. Moreover, the conductivity of AdBlue from different manufacturers may differ substantially, likewise causing more risk of error.

Conducting measurements on a urea solution with an acoustic sensor is described in a number of patent specifications discussed briefly below.

US-2008/0280371 refers to an acoustic sensor adapted to measuring the concentration of urea. The fact that changes in the molecular weight of urea affect the acoustic velocity can be used to determine the concentration. The acoustic sensor may be combined with an NH3-sensitive sensor used to make sure that what is concerned is urea.

DE-102006013263 refers to a method for determining the concentration of urea solutions in a liquid on the basis of the acoustic velocity in the liquid, which is determined by ultrasonic sensors.

The specifications cited refer to devices for determining urea quality but make no comparisons with other liquids.

The object of the present invention is to propose a method and device which can provide assurance that the reducing agent is approved and can do so in a way which does not increase the complexity of the measurements and therefore does not increase costs and the risks of error.

### SUMMARY OF THE INVENTION

The above objects are achieved with the invention defined by the independent claims.

Preferred embodiments are defined by the dependent claims.

According to the invention, the acoustic velocity is evaluated over a certain time, which means that the quality measurement can be made more accurate and that it is then possible with greater certainty to determine what type of liquid is in the tank intended for reducing agent. This can be accomplished without any conductivity measurements at all.

The present invention is based on the fact that acoustic velocities differ at different temperatures. A vehicle's various operating conditions cause the temperature of the liquid contained in the tank intended for reducing agent to vary over time, e.g. T_{night}, T_{winter}, T_{running}, Tₛₜₒₚ, Tᵣₑₛₜ.

Determining the acoustic velocity for the liquid contained in the tank intended for reducing agent at at least two different temperatures and comparing these measured velocities with reference values for the velocity for a reference liquid, i.e. an approved liquid, makes it possible to obtain information about the degree of correspondence between the liquid and the reference liquid, and if the liquid in the tank corresponds sufficiently, i.e. is within a given range, the conclusion is that it is an approved liquid.

It happens in certain cases that the liquid in the tank intended for reducing agent does not reach the temperature required for making the desired quality measurements/distinction. The present invention then makes it possible to use the heating system provided for thawing the liquid in hoses and in the tank to raise the temperature. The electrically heated hoses and water valves which help to circulate the engine cooling water in the tank containing the liquid are controlled by a control unit on board the vehicle which also communicates with the calculation unit in the measuring device.

The invention affords inter alia the advantage of making it possible to distinguish two or more different liquids without using a conductivity sensor.

A further preferred embodiment makes it possible to use an atmospheric pressure sensor to calculate the liquid's compression factor and thereby further increase the measurement accuracy.

### BRIEF DESCRIPTION OF DRAWINGS

FIG. 1 is a graph schematically illustrating the relationship between acoustic velocity and temperature for different liquids.

FIG. 2 is a schematic block diagram illustrating the present invention.

FIG. 3 is a flowchart illustrating the method according to the present invention.

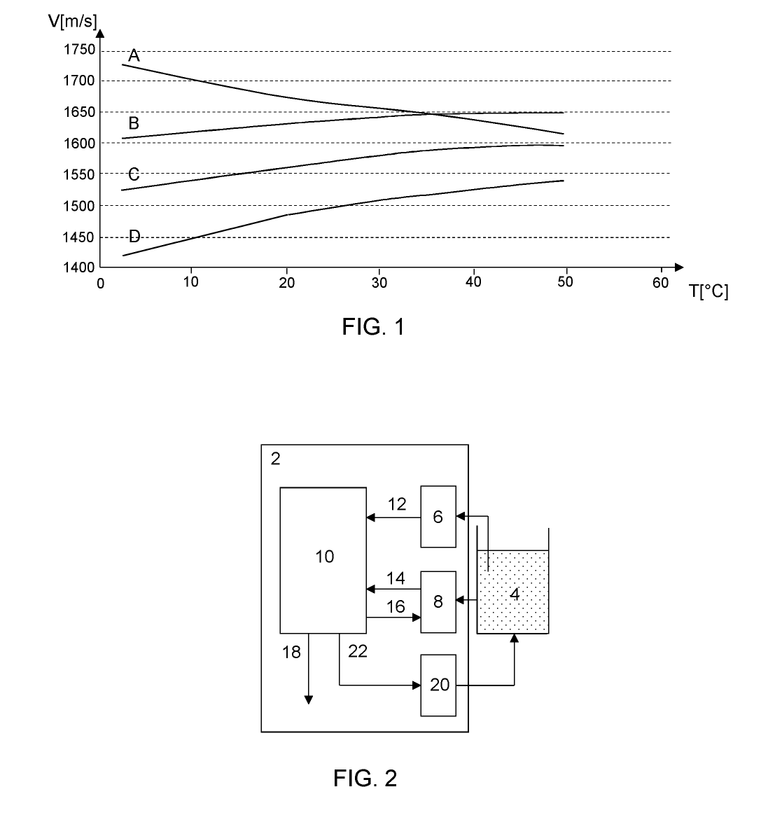

### DETAILED DESCRIPTION OF PREFERRED EMBODIMENTS OF THE INVENTION

The invention will now be described with reference to the block diagram in FIG. 2. The invention comprises a measuring device 2 adapted to testing a liquid 4 used as reducing agent in connection with exhaust cleaning for exhaust gases from a combustion engine (not depicted). The engine is preferably on board a vehicle, e.g. a truck or bus, but other applications are also possible, e.g. on watercraft or in the engineering industry. The reducing agent is for example a urea solution, e.g. of the AdBlue type.

The measuring device 2 comprises a temperature sensor 6 adapted to measuring the temperature in the liquid 4 and an acoustic velocity measuring unit 8 adapted to measuring the acoustic velocity in the liquid. A level gauge (not depicted) is often also provided to measure the level of the liquid 4 in the tank intended for reducing agent.

The acoustic velocity measuring unit 8 may be a conventional acoustic measuring device comprising a transmitter which emits an acoustic wave into the liquid 4, and a receiver which detects the reflected sound wave. Other acoustic measuring devices may also be used within the scope of the present invention.

The size of the tank intended for reducing agent is known, which makes it easy to calculate the acoustic velocity by measuring the time between the wave being emitted and the reflected sound wave being detected and calculating the velocity by dividing the distance by the measured time.

The measuring device 2 further comprises a calculation unit 10.

The temperature sensor 6 is adapted to determining a first temperature T1 for the liquid 4 and to delivering on the basis thereof a temperature signal 12 to the calculation unit 10. The acoustic velocity measuring unit 8 is also adapted to determining a first acoustic velocity v₁ for the liquid 4 at a temperature T1 and to delivering on the basis of a measured velocity an acoustic velocity signal 14 to the calculation unit 10. The temperature sensor 6 is adapted to determining a second temperature T2 for the liquid 4 and to delivering on the basis thereof a temperature signal 12 to the calculation unit. The calculation unit 10 is adapted to calculating the absolute value of a temperature difference ΔT between T1 and T2, i.e. ΔT=|T1−T2|, and to comparing ΔT with a predetermined threshold value T_{TH}. If ΔT exceeds T_{TH}, a control signal 16 is delivered to the acoustic velocity measuring unit 8 to determine a second acoustic velocity v₂ for the liquid 4 at the temperature T2 and to deliver on the basis of the measured velocity an acoustic velocity signal 14 to the calculation unit 10.

According to an embodiment, T_{TH} is 2° C. but any suitable value larger than 1° C. may be chosen.

In other words, the measurement of the second acoustic velocity v₂ should take place when the temperature difference exceeds the threshold value T_{TH}.

The temperature measurement may for example be done continuously at a predetermined measuring interval, e.g. of the order of one or a few seconds or minutes, and the velocity measurement is only done when the temperature difference is large enough.

The calculation unit 10 is then adapted to comparing v₁ and v₂ with respective first and second velocity reference values v_{ref1} and v_{ref2} for a reference liquid at the respective temperatures T1 and T2 and to generating on the basis of the result of the comparison an indicating signal 18. The reference liquid is for example a urea solution which meets all the quality requirements.

The indicating signal 18 is to the effect that the liquid 4 is approved if the measured values v₁ and v₂ are within approved velocity ranges for the reference values, in which case the indicating signal contains for example the information “OK”, and that the liquid 4 is not approved if the values v₁ and v₂ are not within said approved velocity ranges, in which case the indicating signal contains for example the information “not OK”.

The approved velocity ranges may for example be chosen as a maximum percentage deviation from the velocity reference values. This deviation may be of the order of one or a few percent, e.g. maximum 5%.

As discussed above, the liquid 4 in the tank intended for reducing agent will be at different temperatures depending on the different operating situations which the vehicle may be in. Inter alia it may however be desirable to conduct the measurement even when the liquid 4 has undergone no temperature change due to the vehicle's operating situation.

The device then comprises, according to an embodiment, a warming device 20 adapted to warming the liquid 4 in a controlled way after v₁ has been determined. For example, the warming device 20 may take the form of the heating system provided to thaw the reducing agent in hoses and in the container. The warming device may be controlled by a control signal 22 generated by the calculation unit 10.

It is of course possible within the scope of the invention to determine at least one further temperature value and in that case to compare the further value or values thus determined with the previous values determined, to form temperature differences and, if these exceed specific threshold values, to determine velocity values at the respective temperature or temperatures which are compared with corresponding velocity reference values for the reference liquid. This would further increase the reliability of the measurements.

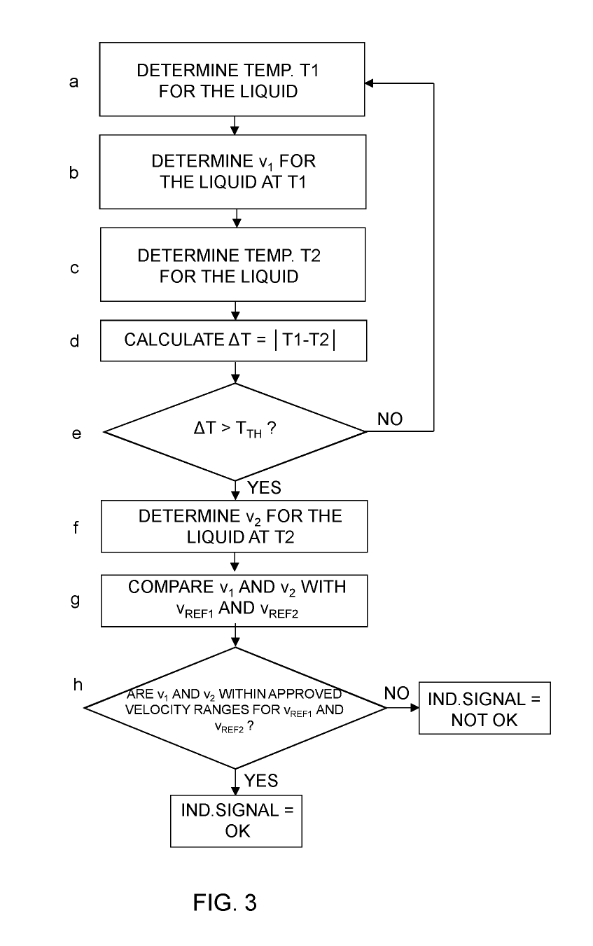

The method will now be described in detail with reference to FIG. 3, which is a flowchart illustrating the method according to the invention.

The invention relates also to a method for testing a liquid used as reducing agent in connection with exhaust cleaning for exhaust gases from a combustion engine.

The method comprises the steps of:

a) determining a first temperature T1 for the liquid;

b) determining an acoustic velocity v₁ for the liquid at the first temperature T1;

c) determining a second temperature T2 for the liquid;

d) calculating the absolute value of a temperature difference ΔT between T1 and T2, i.e. ΔT=|T1−T2|;

e) comparing ΔT with a predetermined threshold value T_{TH} which is preferably 2° C. but may also be any suitable value greater than 1° C.

If ΔT exceeds T_{TH}, the following steps are performed:

f) determining a second acoustic velocity v₂ for the liquid at the temperature T2;

g) comparing v₁ and v₂ with respective first and second velocity reference values v_{ref1} and v_{ref2} for a reference liquid at the respective temperatures T1 and T2, and

h) generating an indicating signal on the basis of the results of the comparison.

The indicating signal is to the effect that the liquid is approved if the measured values v₁ and v₂ are within approved velocity ranges for the reference values, but not approved if v₁ and v₂ are not within said approved velocity ranges.

The approved reference liquid is for example liquid urea which meets all the quality requirements.

As discussed above, it may in certain contexts be appropriate instead to actively warm the liquid in a controlled way, which may be done between steps b) and c).

It is also possible to make further temperature measurements by determining at least one further temperature value and comparing the further value or values thus determined with the previous values determined, forming temperature differences and, if these exceed specific threshold values, determining velocity values at the respective temperature or temperatures which are compared with velocity reference values for the reference liquid. The result is a still more reliable measurement result.

The present invention is not restricted to the preferred embodiments described above. Sundry alternatives, modifications and equivalents may be used. The above embodiments are therefore not to be regarded at limiting the invention's protective scope which is defined by the attached claims.

1. A method for testing a liquid used as a reducing agent in connection with exhaust cleaning for exhaust gases from a combustion engine, characterised in that the method comprises the steps of
a) determining a first temperature T1 for the liquid;
b) determining an acoustic velocity v₁ for the liquid at the first temperature T1;
c) determining a second temperature T2 for the liquid;
d) calculating the absolute value of a temperature difference ΔT between T1 and T2, i.e. ΔT=⊕T1−T2;
e) comparing ΔT with a predetermined threshold value T_{TH}, and if ΔT exceeds T_{TH},
f) determining a second acoustic velocity v₂ for the liquid at the temperature T2;
g) comparing v₁ and v₂ with respective first and second velocity reference values v_{ref1} and v_{ref2} for a reference liquid at the respective temperatures T1 and T2, and
h) generating an indicating signal on the basis of the results of the comparison, wherein the indicating signal is to the effect that the liquid is approved if the measured value v₁ and v₂ are within approved velocity ranges for the reference values, but not approved if v₁ and v₂ are not within said approved velocity ranges.

2. The method according to claim 1, in which T_{TH} is 1° C.

3. The method according to claim 1, further comprising warming the liquid in a controlled way after steps a) and b).

4. The method according to any one of claim 1, further comprising determining at least one further temperature value and comparing the at least one further temperature value thus determined with the previous temperature values determined, forming temperature differences and, if these temperature differences exceed specific threshold values, determining velocity values at the respective temperatures which are compared with velocity reference values for the reference liquid.

5. The method according to claim 1, wherein the reference liquid is liquid urea.

6. A measuring device configured for testing a liquid used as a reducing agent in connection with exhaust cleaning for exhaust gases from a combustion engine, wherein the device comprises:
a temperature sensor configured for measuring the temperature in the liquid and an acoustic velocity measuring unit configured for measuring the acoustic velocity in the liquid;
a calculation unit;
the temperature sensor is configured for determining a first temperature T1 for the liquid and for delivering on the basis thereof a first temperature signal to the calculation unit;
the acoustic velocity measuring unit is configured for determining a first acoustic velocity v₁ for the liquid at the first temperature T1 and for delivering on the basis thereof a first acoustic velocity signal to the calculation unit;
the temperature sensor is configured for determining a second temperature T2 for the liquid and for delivering on the basis thereof a second temperature signal to the calculation unit,
the calculation unit is configured for calculating an absolute value of a temperature difference ΔT between T1 and T2, i.e. ΔT=|T1−T2, and for comparing ΔT with a predetermined threshold value T_{TH};
if ΔT exceeds T_{TH}, the calculation unit is configured for delivering a control signal to the acoustic velocity measuring unit to determine a second acoustic velocity v₂ for the liquid at the second temperature T2 and configured for delivering on the basis thereof a second acoustic velocity signal to the calculation unit, the calculation unit is configured for comparing T1 and T2 with respective first and second velocity reference values v_{ref1} and v_{ref2} for a reference liquid at the respective temperatures T1 and T2, and for generating, on the basis of the results of the comparison, an indicating signal to the effect that the liquid is approved if the measured values v₁ and v₂ are within approved velocity ranges for the reference values, but not approved if the measured values v₁ and v₂ are not within said approved velocity ranges.

7. The measuring device according to claim 6, in which T_{TH} is 1° C.

8. The measuring device according to claim 6, further comprising a warming device configured for warming the liquid in a controlled way after v₁ has been determined.

9. The measuring device according to claim 6, configured for determining at least one further temperature value and for comparing the at least one further value thus determined with the previous values determined, forming temperature differences and, if the temperature differences exceed specific threshold values, determining velocity values at the respective temperatures which are compared with corresponding velocity reference values for the reference liquid.

10. The measuring device according to claim 6, wherein the reference liquid is liquid urea.
